(19) United States
(12) Patent Application Publication
(10) Pub. No.: US 2016/0246920 A1
(43) Pub. Date: Aug. 25, 2016

(54) SYSTEMS AND METHODS OF IMPROVED MOLECULE SCREENING

(71) Applicant: Carmel - Haifa University Economic Corp Ltd., Haifa (IL)

(72) Inventors: Leonid I. BRODSKY, Zichron-Yaakov (IL); Sergey I. Feranchuk, Minsk (BY)

(21) Appl. No.: 14/625,785

(22) Filed: Feb. 19, 2015

(51) Int. Cl. G06F 19/16; C40B 30/02

(52) U.S. Cl. CPC G06F 19/16; C40B 30/02

(57) ABSTRACT

Systems and methods in support of improved molecule screening may assign a key string to each atom of a molecule; and generates for each atom of the molecule, a K-mer sequence, wherein a K-mer sequence comprises an ordered sequence of respective assigned key strings of a defined number of neighboring atoms to a given atom; a molecule K-mer-set comprises all K-mer sequences associated with a particular molecule; and a total K-mer-set comprises all generated K-mer sequences of all the molecule K-mer-sets; identifies a first seed group of K-mer sequences being from the total K-mer-set; generates a molecule index for one or more molecules in the set of molecules based on a particular commonality of a given molecule K-mer-set with the first seed group of K-mer sequences relative to a first predefined threshold; and clusters into a potential cluster, all molecules in the set of molecules having the same molecule index.

### FIELD OF THE INVENTION

The present invention relates generally to molecule screening, and more specifically, to a system and method in support of improved molecule screening.

### BACKGROUND OF THE INVENTION

Various systems and methods exist for organizing and screening data in general, and for organizing and screening molecule data (e.g., data describing aspects of a molecule such as, for example, physical structure, etc.) in particular. Screening (e.g., virtual screening) is a process by which large libraries of data are evaluated to find molecules that may exhibit some characteristic of interest (e.g., some bioactivity of interest), and/or to find relevant samples against which a new sample may be compared. Such screening is typically used, for example, for the purposes of bioassay (biological assessment or determination of the relative strength of a substance (as a drug) by comparing its effect on a test organism with that of a standard preparation). One example of such a database is the Zinc Database, provided by the Shoichet Laboratory in the Department of Pharmaceutical Chemistry at the University of California San Francisco (UCSF). The Zinc Database focuses on biologically relevant compounds, and contains over 35 million compounds, curated from at least 235 different commercial compound suppliers. Due to the sheer breadth of such databases, finding the appropriate molecule or molecules against which to compare a new sample can be a long and arduous task.

Presently available systems for screening (e.g., testing) an entire database, e.g., for bioassay, typically require searching through the entire database against some biological effect to determine relevant results. Such systems would benefit tremendously by a reduction of the database size for screening purposes. However, presently available systems for providing improved screening typically involve organizing data by using a description of a two-dimensional (2D) structure of a molecule, but not using three dimensional (3D) conformers of the molecule, which may be very different in their physic-chemical properties. Furthermore, two-dimensional structures are often defined as having a number of sub-structures by which the structures may be organized, for example, by number of aromatic rings, etc., which represent a knowledge based description of the molecule. The information is stored in a relational database, after which the database may be searched by sub-structure. Such methods do not take into account 3D structure of the molecule and/or its conformers (conformers may be, e.g., molecules having specific orientations of the atoms that varies from other possible orientations by rotations about single bonds), and, therefore, the screening may not be accurate enough and/or not sensitive enough.

### SUMMARY OF EMBODIMENTS OF THE INVENTION

According to embodiments of the invention, there are provided a system and method for or in support of improved molecule screening. Embodiments may be performed on a computer, for example, having a processor, memory, and one or more code sets stored in the memory and executing in the processor. In some embodiments of the method, for each molecule in a set of molecules, each molecule including one or more atoms, the processor may assign a key string to each atom of the molecule, in which a key string may include one or more key attribute indicators of the atom to which the key string is assigned; and generate for each atom of the molecule, a K-mer sequence, in which: a K-mer sequence may include an ordered sequence of respective assigned key strings of a defined number of neighboring atoms to a given atom; a molecule K-mer-set may include all K-mer sequences associated with a particular molecule; and a total K-mer-set may include all generated K-mer sequences of all the molecule K-mer-sets. In some embodiments, the method may identify a first seed group of K-mer sequences being from the total K-mer-set; generate a molecule index for one or more molecules in the set of molecules based on a particular commonality of a given molecule K-mer-set with the first seed group of K-mer sequences relative to a first predefined threshold; and cluster into a potential cluster, all molecules in the set of molecules having the same molecule index.

In some embodiments, the method may include, for each potential cluster, determining whether the molecules in the potential cluster have an overall commonality above a second predefined threshold, such that the potential cluster can be defined as an established cluster; and recording in a database each potential cluster which is defined as an established cluster. In some embodiments, generating the molecule index for one or more molecules in the set of molecules may include identifying a group of one or more K-mer sequences of the given molecule K-mer-set which are common to the molecule K-mer-set and the first seed group, in which each K-mer sequence has an associated K-mer index; and implementing a hash function with respect to the associated K-mer indices of the one or more K-mer sequences of the identified group, in which the molecule index is an output of the hash function. In some embodiments, the clustering into the potential cluster all the molecules in the set of molecules having the same molecule index further may include sorting all molecules with the same molecule index into the potential cluster. In some embodiments, the ordered sequence of respective assigned key strings of each K-mer sequence may be ordered by a relative distance of each of the defined number of neighboring atoms to the given atom.

In some embodiments, the first seed group of K-mer sequences may be identified by a random selection of a predetermined number of K-mer sequences from the total K-mer-set. Embodiments may include removing from the total K-mer-set any K-mer sequence which is included in an established cluster; identifying, by the processor, a second seed group of K-mer sequences from the remaining K-mer sequences in the total K-mer-set; and continuing to define established clusters until one of a predetermined number of seeds groups are identified, and a predetermined number of established clusters are defined. In some embodiments, the one or more key attribute indicators of an atom may include one or more of: potential hydrogen bond donor status, potential hydrogen bond acceptor status, bulkiness, and/or electropositivity. In some embodiments, the one or more atoms of a molecule may further include one or more pseudo-atoms, and/or the key string assigned to a respective pseudo-atom may include a key attribute indicator indicating whether the pseudo-atom is a center of an aromatic ring, or whether the pseudo-atom is a center of a non-aromatic ring.

In some embodiments, the first predefined threshold may include a minimum number of K-mer sequences required to be common to both a given molecule K-mer set and the first seed group. Other thresholds may be used. In some embodiments, determining whether the molecules in the potential cluster have an overall commonality above a second predefined threshold may further include: for one or more randomly chosen sortings of molecules within the potential cluster, identifying a number of matching K-mer sequences between one or more pairs of molecules in a given sorting; calculating a characterizing statistic for the potential cluster based on the identified number of matching K-mer sequences between the one or more pairs of molecules across at least one of the one or more randomly chosen sortings; and determining whether the overall commonality is above the second predefined threshold based on the calculated characterizing statistic; in which the characterizing statistic may include at least one of an average, a mean, a median, a mode, a standard deviation, and/or a statistical significance score of the potential cluster.

Some embodiments may further include receiving a previously unscreened molecule and screening the previously unscreened molecule against one or more established clusters recorded in the database. Some embodiments may further include selecting one or more representative molecules from each established cluster; and generating a cluster representation database including the selected representative molecules. Some embodiments may further include receiving a previously unscreened molecule and screening the previously unscreened the molecule against the selected representative molecules.

These and other aspects, features and advantages will be understood with reference to the following description of certain embodiments of the invention.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIG. 1 is a high level diagram illustrating an example configuration of a system for or in support of improved molecule screening, according to at least one embodiment of the invention;

FIG. 2 is a schematic flow diagram illustrating a method for or in support of improved molecule screening according to at least one embodiment of the invention;

FIG. 3 is an illustrative representation of an example linearization of 3D structures of two molecules, according to at least one embodiment of the invention;

FIG. 4A is a depiction of two 3D virtual molecule models according to at least one embodiment of the invention;

FIG. 4B is a linearization of 3D structures of the two molecules depicted in FIG. 4A in an example alignment, according to at least one embodiment of the invention;

FIG. 5 is an example alignment of the two molecules of FIG. 4A, according to a least one embodiment of the invention;

FIG. 6 is example graphical representation of a clustering of potential clusters, according to at least one embodiment of the invention; and

FIG. 7. Is an example representation of an established cluster, according to at least one embodiment of the invention.

It will be appreciated that for simplicity and clarity of illustration, elements shown in the figures have not necessarily been drawn accurately or to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

### DETAILED DESCRIPTION OF EMBODIMENTS OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently.

Embodiments of the invention provide systems and methods in support of improved molecule screening (e.g., screening and/or clustering of molecule data from a database of small molecules). For example, embodiments of the invention may improve screening by providing a clustering system and method which allow a seventy-times (or more) reduction in bioassay screening from hit-to-lead development. Other embodiments may have other (e.g. less or more) improvements or benefits. Such a clustering system and method may be based, for example, on a process of linearization of a molecule's three-dimensional (“3D”) structure (e.g., a virtual representation, in digital form, of a real molecule), as described in detail herein. Molecule linearization, as understood herein, is a process by which a 3D structure of a molecule, for example a molecule composed of one or more heavy atoms, may be described as a set of key strings (e.g., a set of strings or sequences or words, symbols or characters, each string containing one or more key attribute indicators—hereinafter “keys” which may be for example sets of characters or symbols), in which the keys indicate or represent different attributes or properties of an atom in the molecule, and each atom of the molecule is assigned a key string.

In some embodiments, each atom of a molecule may be assigned or associated with a key string of binary elements (e.g., one or more key attribute indicators) corresponding to different properties of interest with regard to the atom. Such properties may include, for example, one or more of the following (other attributes may be used): (1) potential hydrogen bond Donor (key—“HBD”); (2) potential hydrogen bond Acceptor (key—“HBA”); (3) Bulkiness (key—“Blk”); (4); and Electropositivity (key—“eP”). Furthermore, in embodiments where the one or more atoms of a molecule further includes one or more pseudo-atoms (e.g., where one or more pseudo-atoms are included in the 3D molecule structure), additional keys may indicate, for example, (5) whether a pseudo-atom is a center of an aromatic ring (key—“cAR”), or (6) whether the pseudo-atom is a center of a non-aromatic ring (key—“cR”). For example, a bulky, Sybyl-electropositive atom that can serve as a hydrogen bond donor and acceptor, and is also a center of an aromatic ring may be assigned the following key string: _Blk_eP_HBA_HBD_cAR. Of course, in other embodiments, other properties of interest may also be indicated, in addition or in the alternative.

In some embodiments, the bulkiness of an atom may be assigned or determined based on its volume and the volumes of its nearest neighboring atoms, j, as reflected in their van der Waals radii, wᵢ and wⱼ, respectively. In such embodiments, an atom may be considered to be bulky if, for example:

$${w}_{t}^{3} + {\sum }_{j} {w}_{j}^{3} > 10 {Å}^{3}$$

The nearest neighboring atoms, j, may be selected, for example, according to van der Waals contacts, in which only heavy atoms are considered, and van der Waals radii are calculated.

In some embodiments, the electronegativity (e.g., the counterpart of electropositivity) of an atom may reflect, for example, the hydrophobicity of the atom, and may be assigned following Pauling's definition and SYBYL atom types. (SYBYL atom types were devised by Tripos Inc., 1699 South Hanley Road, St Louis, Mo. 63144-2913, USA (http://www.tripos.com) and are used to classify atoms according to their environment, e.g., “C.3”, “C.2” and “C.1” mean, respectively, sp3, sp2 and sp hybridized carbon; “N.am” means amide nitrogen.) An atom may be indicated at electropositive when its Pauling electronegativity and the Pauling electronegativity of its neighbors is 2.5 or less. It should be noted that, in some embodiments, the bulkiness and/or electropositivity of an atom may depend on the molecule conformation, and conformational changes may alter the bulkiness and electropositivity status of atoms.

A hydrogen donor in a hydrogen bond may be understood as the atom to which a hydrogen atom participating in a hydrogen bond is covalently bonded, and is usually a strongly electronegative atom such as N, 0, or F. A hydrogen acceptor may be understood as a neighboring electronegative ion or molecule, which possesses a lone electron pair in order to form a hydrogen bond. As such, an atom in a molecule may be identified as being a potential hydrogen bond Donor or Acceptor depending on the particular properties of the atom.

In some embodiments, as described herein, a K-mer sequence may be generated for each atom of a molecule, in which a K-mer sequence includes, for example, an ordered sequence of key strings of a defined number of neighboring atoms to a given atom. In some embodiments, key strings may be ordered in a defined manner, for example, by distance from the center of a given atom (e.g., closest to farthest from the atom), by distance from the edge of an atom, by relative size of neighboring atoms, etc. Furthermore, in some embodiments, the number of neighboring atoms may be a predetermined number of closest atoms to a given atom, when assessing the 3D structure of a given molecule. As such, in some embodiments, a molecule K-mer-set may include all K-mer sequences associated with a particular molecule (e.g., a set of all K-mer sequences of all atoms in a molecule), and each K-mer sequence may include one or more key strings representing a defined set of attributes of neighboring atoms to a given atom.

By way of example, the following K-mer sequence may be generated, in accordance with various embodiments of the invention, for a particular atom Aₗ of a given molecule M:
molecule M, atom A₁:_eP;_eP;_eP;_eP;_HBA_eP;_HBA_eP; _HBA_eP;
   This example K-mer sequence represents a predefined neighborhood of seven atoms and contains seven key strings (separated by semi-colons), each of which indicates one or more attributes of a neighboring atom to atom A₁. In this example, the key strings are ordered by 3D distance to the center of the particular atom A₁, from nearest to farthest. As such, in this example, the four nearest atoms in the neighborhood of atom A₁ all exhibit the same singular attribute of electropositivity (“_eP”) without exhibiting any other attributes of interest, while the next three nearest atoms to atom A₁ exhibit both the attribute of being able to serve as a hydrogen bond acceptor (“_HBA”), and the attribute of electropositivity (“_eP”).

As described herein, embodiments of the invention may use linear representations of molecules, for example, to compare one molecule to another molecule (e.g., 3D alignment of two molecules), and/or to create clusters of (or to “cluster”) molecules in a database. Such clusters may then be assigned a representative molecule, and representative molecules may then be screened (for example, data of 35,000 representative molecules representing 35,000 clusters of molecules), rather than having to screen an entire database of molecules (containing, for example, data of 2.5 million molecules).

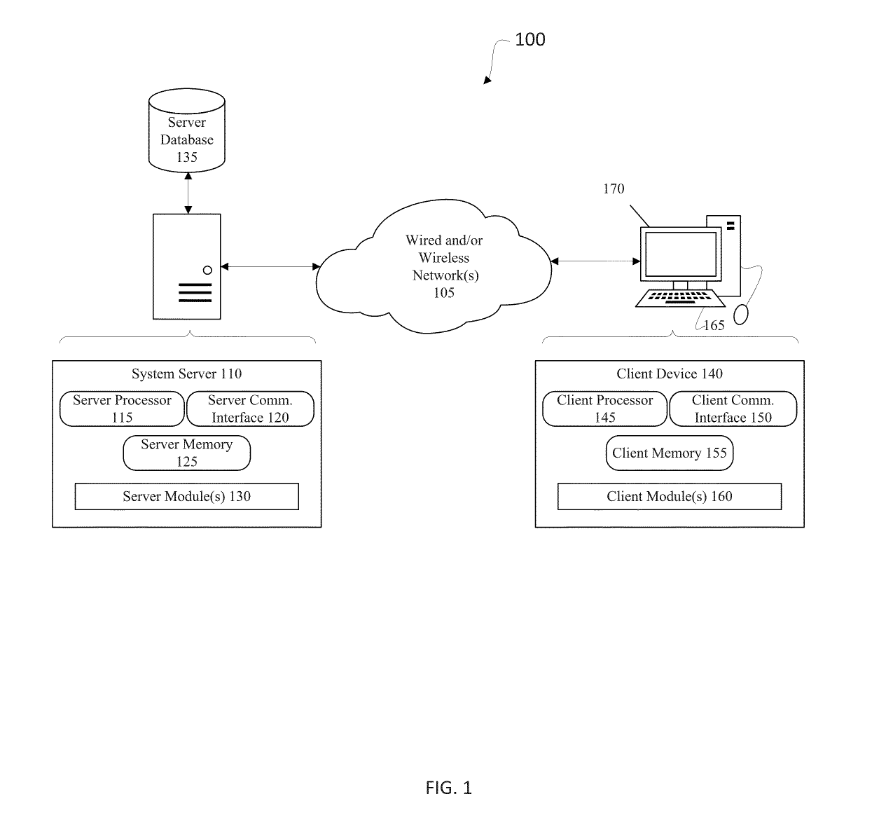

FIG. 1 is a high level diagram illustrating an example configuration of a system 100 performing or in support of improved molecule screening, according to at least one embodiment of the invention. System 100 may include network 105, which may include the Internet, one or more telephony networks, one or more network segments including local area networks (LAN) and wide area networks (WAN), one or more wireless networks, or a combination thereof. System 100 also includes a system server 110 constructed in accordance with one or more embodiments of the invention. In some embodiments, system server 110 may be a stand-alone computer system. In other embodiments, system server 110 may include a network of operatively connected computing devices, which communicate over network 105. Therefore, system server 110 may include multiple other processing machines such as computers, and more specifically, stationary devices, mobile devices, terminals, and/or computer servers (collectively, “computing devices”). Communication with these computing devices may be, for example, direct or indirect through further machines that are accessible to the network 105.

System server 110 may be any suitable computing device and/or data processing apparatus capable of communicating with computing devices, other remote devices or computing networks, receiving, transmitting and storing electronic information and processing requests as further described herein. System server 110 is therefore intended to represent various forms of digital computers, such as laptops, desktops, workstations, personal digital assistants, servers, blade servers, mainframes, and other appropriate computers and/or networked or cloud based computing systems capable of employing the systems and methods described herein.

System server 110 may include a server processor 115 which is operatively connected to various hardware and software components that serve to enable operation of the system 100. Server processor 115 serves to execute instructions or software to perform various operations relating to chip-design testing and analysis, and other functions of embodiments of the invention as will be described in greater detail below. Server processor 115 may be one or a number of processors, a central processing unit (CPU), a graphics processing unit (GPU), a multi-processor core, or any other type of processor, depending on the particular implementation.

System server 110 may be configured to communicate via server communication interface 120 with various other devices connected to network 105. For example, server communication interface 120 may include but is not limited to, a modem, a Network Interface Card (NIC), an integrated network interface, a radio frequency transmitter/receiver (e.g., Bluetooth wireless connection, cellular, Near-Field Communication (NFC) protocol, a satellite communication transmitter/receiver, an infrared port, a USB connection, and/or any other such interfaces for connecting the system server 110 to other computing devices and/or communication networks such as private networks and the Internet.

In certain implementations, a server memory 125 is accessible by server processor 115, thereby enabling server processor 115 to receive and execute instructions such as code, stored in the memory and/or storage in the form of one or more software modules 130, each module representing one or more code sets or software. The software modules 130 may include one or more software programs or applications (collectively referred to as the “server application”) having computer program code or a set of instructions executed partially or entirely in or by server processor 115 for carrying out operations for aspects of the systems and methods described herein, and may be written in any combination of one or more programming languages. Server processor 115 may be configured to carry out embodiments of the present invention by for example executing code or software, and may be or may execute the functionality of the modules as described herein.

It should be noted that in accordance with various embodiments of the invention, server modules 130 may be executed entirely on system server 110 as a stand-alone software package, partly on system server 110 and partly on a client device 140, or entirely on client device 140.

Server memory 125 may be, for example, a random access memory (RAM) or any other suitable volatile or non-volatile computer readable storage medium. Server memory 120 may also include storage which may take various forms, depending on the particular implementation. For example, the storage may contain one or more components or devices such as a hard drive, a flash memory, a rewritable optical disk, a rewritable magnetic tape, or some combination of the above. In addition, the memory and/or storage may be fixed or removable. In addition, memory and/or storage may be local to the system server 110 or located remotely.

In accordance with further embodiments of the invention, system server 110 may be connected to one or more database(s) 135, for example, directly or remotely via network 105. Database 135 may include any of the memory configurations as described above, and may be in direct or indirect communication with system server 110. In some embodiments, database 135 stores molecule and/or cluster data, as described herein.

As described herein, among the computing devices on or connected to the network 105 may be one or more client devices 140. Client device 140 may be any standard computing device. As understood herein, in accordance with one or more embodiments, a computing device may be a stationary computing device, such as a desktop computer, kiosk and/or other machine, each of which generally has one or more processors, such as client processor 145, configured to execute code or software to implement a variety of functions, a client communication interface 150, a computer-readable memory, such as client memory 155, for connecting to the network 105, one or more client modules, such as client module(s) 160, one or more input devices, such as input devices 165, and one or more output devices, such as output devices 170. Typical input devices, such as, for example, input devices 165, may include, for example, a keyboard, a pointing device (e.g., mouse or digitized stylus), a web-camera, and/or a touch-sensitive display, etc. Typical output devices, such as, for example, output device 170 may include one or more of a monitor, display, speaker, printer, etc.

In some embodiments, client module 160 may be executed by client processor 145 to provide the various functionalities of client device 140. In particular, in some embodiments, client module 160 may provide a client-side interface with which a user of client device 140 may interact, to, among other things, provide a previously unscreened molecule for screening against one or more established clusters recorded in the database 135, and/or against one or more selected representative molecules, as described herein.

Additionally or alternatively, a computing device may be a mobile electronic device (“MED”), which is generally understood in the art as having hardware components as in the stationary device described above, and being capable of embodying the systems and/or methods described herein, but which may further include componentry such as wireless communications circuitry, gyroscopes, inertia detection circuits, geolocation circuitry, touch sensitivity, among other sensors. Non-limiting examples of typical MEDs are smartphones, personal digital assistants, tablet computers, and the like, which may communicate over cellular and/or Wi-Fi networks or using a Bluetooth or other communication protocol. Typical input devices associated with conventional MEDs include, keyboards, microphones, accelerometers, touch screens, light meters, digital cameras, and the input jacks that enable attachment of further devices, etc.

In some embodiments, client device 140 may be a “dummy” terminal, by which processing and computing may be performed on system server 110, and information may then be provided to client device 140 via server communication interface 120 for display and/or basic data manipulation. In some embodiments, modules depicted as existing on and/or executing on one device may additionally or alternatively exist on and/or execute on another device.

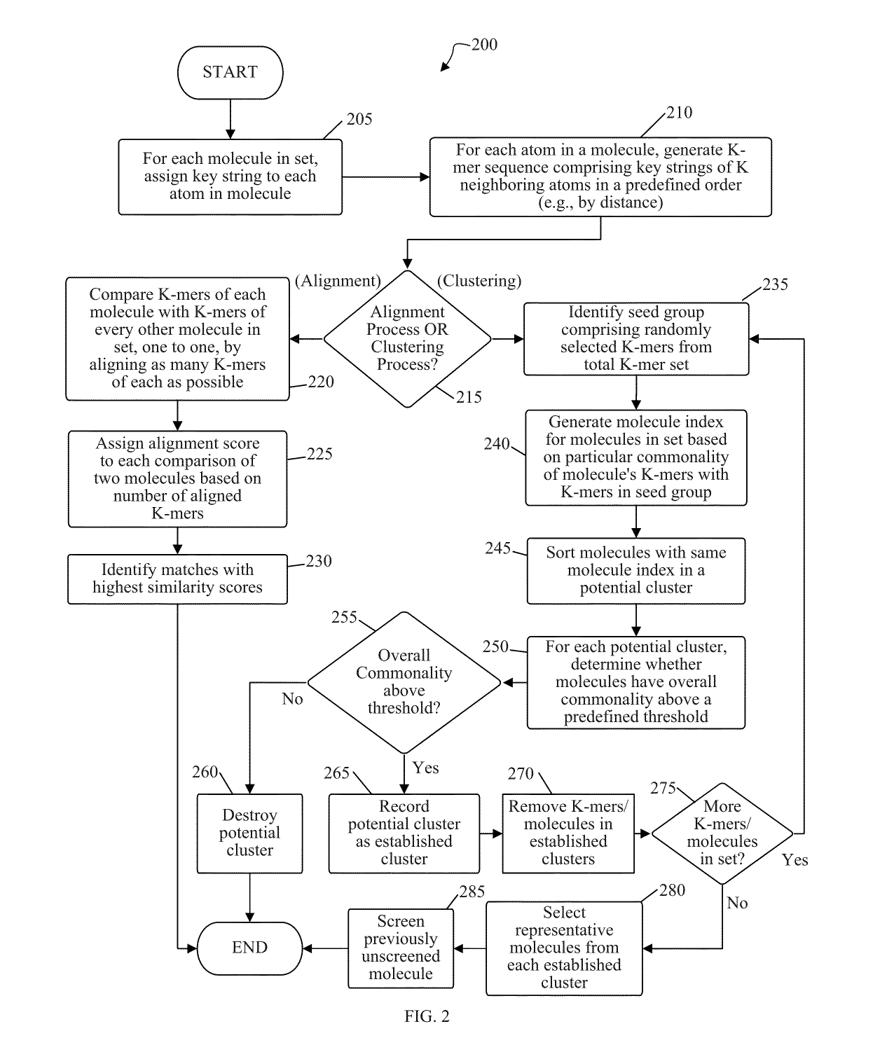

FIG. 2 is a schematic flow diagram illustrating a method 200 of improved molecule screening according to at least one embodiment of the invention. In some embodiments, method 200 may be performed on a computer (e.g., system server 110) having a processor (e.g., server processor 115), memory (e.g., server memory 125), and one or more code sets or software (e.g., server module(s) 130) stored in the memory and executing in or executed by the processor.

At step 205 the server may be provided with a set of molecules (e.g., a data structure representing a set molecules, each molecule including one or more atoms), typically from a molecule database, as described herein. For each molecule in a set of molecules the processor may assign a key string to each atom of the molecule (e.g., the processor may link or assign a data structure representing a string to a data structure representing each atom of the molecule). As described herein a key string may include one or more key attribute indicators of the atom to which the key string is assigned. In some embodiments, the one or more key attribute indicators of an atom may include, for example, one or more of the following: potential hydrogen bond donor status, potential hydrogen bond acceptor status, bulkiness, and/or electropositivity. Of course, in other embodiments, other attributes of interest may also be indicated, in addition or in the alternative. When discussed herein, the manipulation of molecules, atoms, and other real world or physical items typically refers to manipulation of data structures describing molecules, atoms and items.

For example, in some embodiments, when the one or more atoms of a molecule includes one or more pseudo-atoms (as described herein), the key string assigned to a respective pseudo-atom may include a key attribute indicator indicating whether the pseudo-atom is a center of an aromatic ring, or whether the pseudo-atom is a center of a non-aromatic ring. A pseudo-atom, as understood herein, may be a position (represented by data) in the 3D structure of a molecule that does not correspond to an actual atom in the molecule, but is some sort of average of positions of actual atoms. Pseudo-atoms are often incorporated in virtual molecule models, as they provide researchers with the opportunity to analyze features of a molecule that would be otherwise unavailable. In some embodiments, assigning may mean linking, tagging, referencing, cross referencing in a database, and/or otherwise associating a key string to each atom of the molecule.

At step 210, the processor may generate, for each atom of the molecule, a K-mer sequence. As described in detail herein, a K-mer sequence includes an ordered sequence of respective assigned key strings of a defined number of neighboring atoms to a given atom. For example, a K-mer sequence of length K will have K key strings representing K neighboring atoms, and the given atom itself need not be represented in the K-mer sequence. As a K-mer sequence may be generated for each atom in a molecule, the number of atoms may determine the number of K-mer sequences associated with a particular molecule. Therefore, a molecule K-mer-set may be defined which includes all K-mer sequences associated with a particular molecule. Furthermore, a total K-mer-set may be defined, which includes all generated K-mer sequences of all the molecule K-mer-sets. In some embodiments, data reflecting these sets may be overlapping, e.g., one set of data may reflect all K-mer sequences that have been generated based on the provided set of molecules (e.g., the total K-mer-set), while also indicating from which particular molecule each K-mer sequence has been generated (e.g., the total K-mer-set).

In some embodiments, the ordered sequence of respective assigned key strings of each K-mer sequence may be ordered by a relative distance of each of the defined number of neighboring atoms to the given atom. In some embodiments, the order of the sequence of key strings in a K-mer sequence may be determined based on relative proximity/distance, for example, from the center of a given atom to neighboring atoms (or centers of neighboring atoms) being accounted for, e.g., from closest to furthest or vice versa. Of course, in other embodiments, other orders may also be implemented, e.g., by size, by weight, etc., provided the method of ordering is consistent for all K-mer sequences in the total K-mer-set (e.g., for all K-mer sequences of all molecules in the molecule set).

At step 215, depending on the desired screening process, a determination may be made as to whether to implement an alignment process (e.g., steps 220-230) or a clustering process (e.g., steps 235-285). In some embodiments, such a determination may be made by the processor, based on input provided by an end user, etc. (e.g., via a client device such as client device 140). In other embodiments, a determination may be made by the processor, for example, based on the number of molecules in the molecule set, and/or the number of K-mer sequences generated.

At step 220, in embodiments in which an alignment process is implemented, the processor may compare K-mer sequences of each molecule in the molecule set with K-mer sequences of every other molecule in the set, one to one, by aligning, in 3D space, as many K-mer sequences of each molecule as possible. At step 225, the processor may assign an alignment score to each comparison of two molecules based on the number of aligned K-mer sequences. Finally, at step 230, matches with the highest similarity score based on the alignment may be identified. In some embodiments, a similarity score may be, for example, a number or index representing a percentage of alignment (e.g., 95% alignment), or some other indication quantifying the similarity of two compared molecules, as a pair and/or relative to the other molecules in the set.

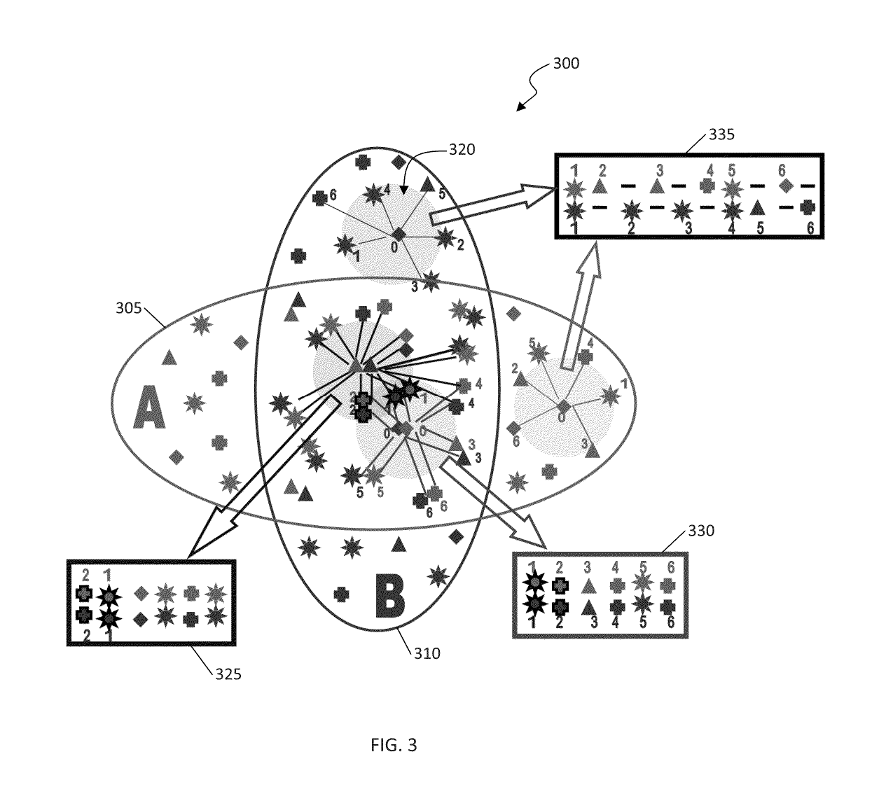

Turning briefly to FIG. 3, an illustrative representation of an example linearization (300) of 3D structures of two molecules is shown according to at least one embodiment of the invention. Two representative molecules, molecule A (305) and molecule B (310), are shown with various symbolic representations of key strings (315) inserted in representative locations of atoms of each molecule. Additionally, four examples of neighborhoods of atoms (320), with each set of neighboring atoms labeled, e.g., one through six, are indicated in relation to four given atoms, each labeled, e.g., zero. As described herein, neighboring atoms to a given atom (and their respective key strings) may make up an ordered K-mer sequence. In this illustrative embodiment, two linear comparisons of K-mer sequences (325 and 330) are shown to have a perfectly matching 3D alignment, while a third comparison (335) is shown to have some matching key strings and some misaligned or non-matching key strings.

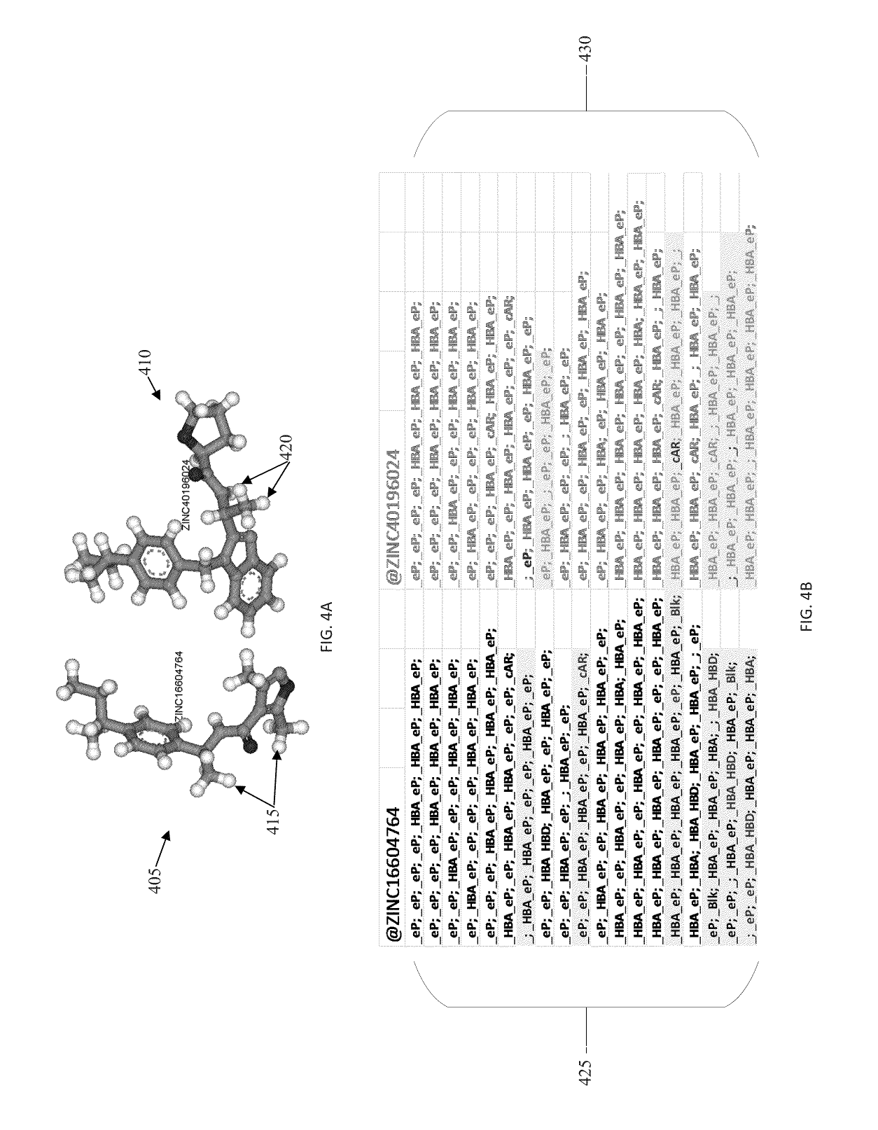

Turning now briefly to FIGS. 4A-4B, two 3D virtual molecule models (405 and 410) are shown (FIG. 4A), along with a linearization of 3D structures of the two molecules in an example alignment (FIG. 4B), according to a least one embodiment of the invention. In the example of FIGS. 4A-4B, the molecules are from Zinc Database and are denoted @ZINC16604764 and @ZINC4019624. As depicted in FIG. 4A, each molecule includes two or more atoms (e.g., atom(s) 415 of molecule 405, atom(s) 420 of molecule 410, etc.) that are bonded together. Linearizations of the two molecules may be compared (for example, as shown in FIG. 4B) and their respective molecule K-mer-sets (425 and 430), including all K-mer sequences associated with each particular molecule, are aligned, side-by-side, as closely as possible.

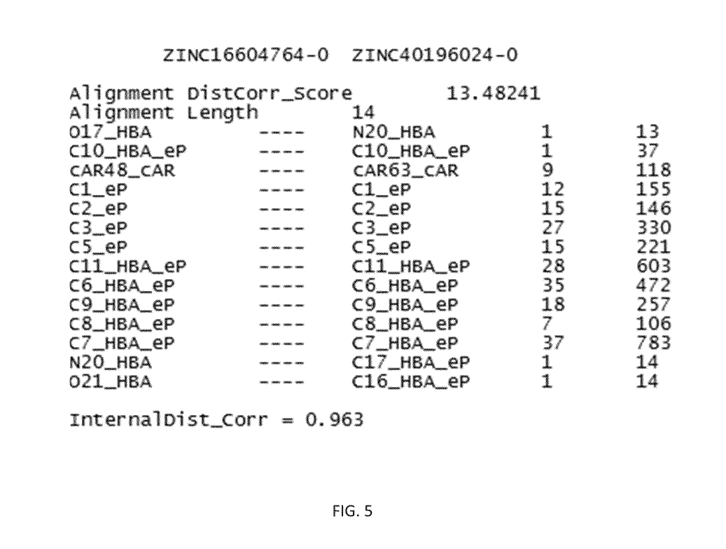

Turning now briefly to FIG. 5, an example alignment of the two molecules of FIG. 4A is shown according to a least one embodiment of the invention. In the example alignment, molecules @ZINC16604764 and @ZINC4019624 are shown aligned via the key strings of their respective atoms. As such, in some embodiments, various calculations (e.g., various scores) and/or comparisons may be made with respect to the alignment. For example, an overall score for a found match of two molecules (e.g., the alignment of their respective atoms) may be calculated (e.g., represented as “Alignment DistCorr_Score”). In the example embodiment, Alignment DistCorr_Score=13.48241, which, in some embodiments, may be the number of atoms in the alignment (e.g., alignment length) multiplied by a Pearson correlation between two vectors of inter-atom 3D distances inside each of the molecules (e.g., InternalDist_Corr=0.963). In some embodiments, for a given alignment of two molecules, atoms of each molecule may be aligned, e.g., in columns (as shown), in rows, etc. In the example alignment of FIG. 5, the left-most column contains a list of names of atoms of molecules @ZINC16604764 (e.g., “017” represents the first atom in the alignment) and includes a list of the atom's keys (e.g., “_HBA”). Correspondingly, similar notation for a matching atom in the second molecule @ZINC4019624 is displayed in the adjacent column (e.g., “N20_HBA”). The next two columns may represent various scores for this match of atoms. For example, each value in the next column may represent a score of the a linear alignment (e.g., the best linear alignment) of local neighborhoods where two given atoms match, while the values in the last column (e.g., the right-most column) may be a sum of scores of all linear alignments of local neighborhoods where two given atoms match. Of course, in other embodiments, other and/or additional scores and/or comparisons may also be calculated as desired.

As this process is based on three-dimensional alignment of atoms of a pair of molecules, two molecules which are identified as having a high similarity score are typically expected to have a relatively high degree of structural and/or attribute similarity with a high degree of accuracy. However, comparing the 3D alignment of a previously unscreened molecule with every molecule in a database of 2.5 million or 3.5 million molecules, for example, may require both tremendous computational power (e.g., many servers) and/or a substantial amount of time. As such, a clustering process may be implemented, as described herein, which may dramatically increase efficiency while providing a sufficient level of accuracy.

Continuing at step 235 of FIG. 2, in embodiments in which a clustering process is implemented, the processor may identify or choose a first seed group of K-mer sequences being from (e.g., being a subset of) the total K-mer-set. In some embodiments, the first seed group may be identified or chosen by a random selection of a predetermined number of K-mer sequences from the total K-mer-set. A seed group may include, for example, a selection of 5,000 K-mer sequences taken from among millions of K-mer sequences that have been previously generated based on the provided set of molecules. In some embodiments, the first seed group may be removed from the total K-mer-set, and stored separately, for example, elsewhere in the memory. In other embodiments, the first seed group may simply be flagged with a seed indication. The first seed group may then be used for comparison against one or more other K-mer sequences in the total K-mer-set, as described herein.

At step 240, the processor may generate a molecule index for one or more molecules in the set of molecules based, for example, on a commonality (e.g., a particular commonality) of a given molecule K-mer-set with the first seed group of K-mer sequences relative to a first predefined threshold. Commonality, as described herein, may be understood as a common sharing of one or more features, attributes and/or qualities among two or more items being compared. As two or more items being compared may have a plurality of common features, attributes and/or qualities, for example, a particular commonality, as described herein, may be understood as a predefined and/or predetermined commonality (e.g., a commonality of interest) among two or more items, e.g., with respect to one or more particular features, attributes and/or qualities. As described herein, a molecule index may be, for example, one or more numeric, alphabetic, or alphanumeric characters that represents a particular molecule in the database. In some embodiments, in order to cluster (e.g., sort, store together, group, or otherwise indicate an association between) molecules with the same K-mer sequences in common with the first seed group into potential clusters, a molecule index may first be generated for each molecule, as described herein, and molecules with the same molecule index may be clustered together (e.g., sorted into potential clusters).

In some embodiments, a molecule index may be generated for one or more molecules in the set of molecules, for example, by comparing the K-mer sequences of each molecule with the first seed group, and generating a molecule index based on, for example, the K-mer sequences common to both the particular molecule being compared and the first seed group. In some embodiments, a goal of comparing each molecule with the first seed group is to sort all molecules having the same K-mer sequences in common with the first seed group into potential clusters of molecules. Potential clusters, as described herein, may be initial groups of molecules having some minimum common feature or features, such as, for example, the same number of common K-mer sequences to the first seed group. As such, there may be a number of molecules with K-mer-sequences in common with various K-mer sequences of the first seed group, and, in embodiments of the invention, they may be sorted based on their respective commonalities.

In some embodiments, a first predefined threshold may be implemented with regard to the comparison. A predefined threshold may be, e.g., a minimum number of K-mer sequences required to be common to both a given molecule K-mer set and the first seed group. For example, if the first predefined threshold is that each molecule have a minimum of the same one common K-mer sequence with the first seed group (e.g., x≧1), then for molecules with no commonality (e.g., molecule K-mer-sets with no K-mer sequences in common with any K-mer sequences of the first seed group and/or molecules with one uniquely common K-mer sequence with the first seed group), in some embodiments, no cluster will be formed for these molecules. By way of another example, if the first predefined threshold is set at a minimum of three (3) common K-mer sequences (e.g., x≧3), molecules with only two (2) of the same common K-mer sequences with the seed set may not be placed in a potential cluster. In some embodiments, a higher amount of particularly common K-mer sequences may be desired for potential clusters. For example, if a large number of molecules are known to share the same one (1) K-mer sequence, then the fact that a given molecule has this one K-mer sequence in common with the first seed group may not be as informative as identifying a potential cluster of a number of molecules all having the same three (3) K-mer sequences in common with the first seed group. Of course, in some embodiments, having even a minimum number of common K-mer sequences may be sufficient for placing molecules in a potential cluster.

In some embodiments, a molecule index may be generated by first identifying a group of one or more K-mer sequences of a given molecule K-mer-set which are common to the molecule K-mer-set and the first seed group, as described herein. In some embodiments, each K-mer sequence may have an associated K-mer index. A K-mer index may be, for example, one or more numeric, alphabetic, or alphanumeric characters that represents a particular K-mer sequence in the database. K-mer indices may be assigned, for example, randomly, or based on a K-mer sequence's location in the database, etc. (e.g., by row number). As such, in some embodiments, the processor may implement a mathematical or other computational function, such as, for example, a hash function, with respect to the associated K-mer indices of the one or more K-mer sequences of the identified group of one or more K-mer sequences of a given molecule K-mer-set which are common to the molecule K-mer-set and the first seed group. A hash function, as understood herein, may be any function that may be used to map digital data of arbitrary size to digital data of fixed size, with slight differences in input data producing large differences in output data. (This process may be referred to as “hashing”.) Therefore, hashing the K-mer indices of the identified group of one or more K-mer sequences may generate an output (e.g., the molecule index) that uniquely corresponds to the identified group, in which the molecule index is an output of the hash function.

By way of example, in some embodiments, a hash function may be performed as follows. All K-mer sequences in a molecule K-mer-set may be sorted, e.g., alphabetically or in lexicographical order, within a database (e.g., in a table), and each K-mer sequence may be provided a K-mer index (e.g., a row number), as described herein. The processor may, for example, calculate a log of each K-mer index, and then calculate, e.g., a sum of the various resulting logs. The resulting sum, in this example, may be used as the molecule index for the respective molecule. Of course, simpler or more complex hash functions may be implemented. Likewise, other computational functions or representations may be used in place of a hash function, provided that the resulting output uniquely corresponds to the input (e.g., the molecule indices).

At step 245, the processor may cluster, into a potential cluster, all molecules in the set of molecules having the same molecule index. In some embodiments, clustering may be accomplished, e.g., by sorting all molecules with the same molecule index into the potential cluster. As described herein, all molecules with the same K-mer sequences in common with the first seed group have the same molecule index. The processor may, for example, search the database for all instances of a given molecule index and cluster the corresponding molecules together in a potential cluster. In some embodiments, the processor may, for example, assign a label, tag, or other indicator, indicating a molecule as being part of a potential cluster. In other embodiments, data representing the respective molecules may be stored together in the database (e.g., in a table, as a list, etc.). In some embodiments, the K-mer sequences of molecules in a potential cluster may be stored together in the database, e.g., in a randomly sorted order, alphabetically, alphanumerically, or lexicographically.

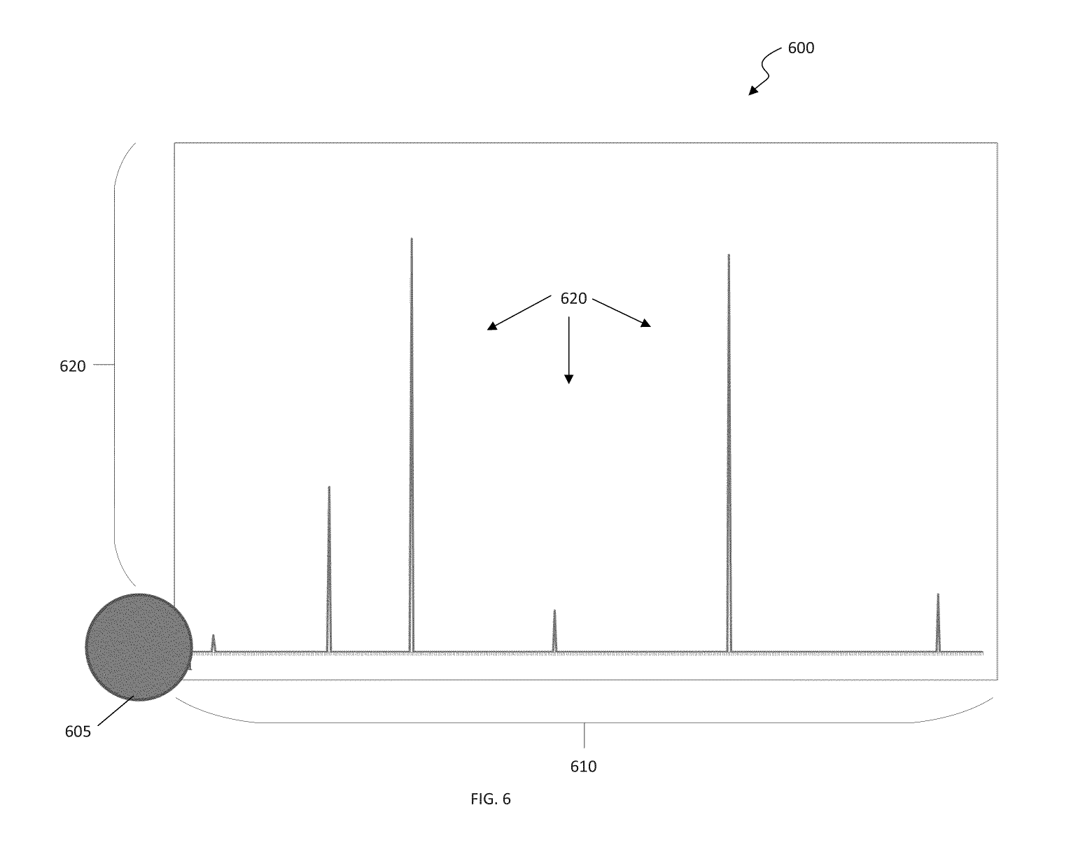

Turning briefly to FIG. 6, an example graphical representation 600 of a clustering of potential clusters is shown according to at least one embodiment of the invention. In the example, for a randomly selected seed group (605), markers representing molecules are shown sorted along the x-axis (610) according to the molecule index of each molecule. The sorting, in this example, yields six (6) potential clusters (615) of various sizes, in which the y-axis (620) indicates the number of molecules with the same molecule index, e.g., the number of molecules in a given potential cluster.

Continuing at step 250 of FIG. 2, for each potential cluster that has been identified, the processor may determine whether the molecules in the potential cluster have an overall commonality above a second predefined threshold, such that the potential cluster can be defined as an established cluster. For example, a potential cluster may have a certain number of molecules therein, each molecule having the same K-mer sequence(s) in common with the first seed group. However, in order for a potential cluster to be defined as an established cluster, a higher level of commonality between the molecules that make up the potential cluster may be desired. As such, in some embodiments, for one or more sortings of molecules within a potential cluster (e.g., randomly chosen sortings, etc.), the processor may first identify a number of matching K-mer sequences between one or more pairs of molecules in a given sorting (e.g., neighboring molecules in a given sorting).

By way of example, a particular potential cluster may contain 56 molecules clustered therein. The 56 molecules may have been stored together in a database table as described herein, and listed in a random order (e.g., randomly sorted). In some embodiments, each molecule may be paired with one or more neighboring molecules on the list (e.g., the molecule above or before a given molecule and/or the molecule below or after it on the list). Of course, the first and last molecules in the list, which may have only one neighboring molecule on the list, may also be paired with each other, for example. It should be noted that, in some embodiments, pairs of molecules may be identified based on any number of selection procedures (e.g., selecting every two molecules, every other molecule, etc.). In some embodiments, each pair of neighboring molecules may be compared and a number of matching K-mer sequences between the molecules in a given pair may be identified.

In some embodiments, the processor may then calculate a characterizing statistic for the potential cluster based on the identified number of matching K-mer sequences between the one or more pairs of neighboring molecules across at least one of the one or more randomly chosen sortings. A characterizing statistic may be, e.g., an average, a mean, a median, a mode, a standard deviation, and/or a statistical significance score (e.g., a “power” score as described herein) of the potential cluster. A power score may be calculated, for example, by multiplying the mean with the square root of the number of molecules in a cluster. For a particular potential cluster, for example, the mean number of matching K-mer sequences between the molecules in a given pair may be 20.4070, and the standard deviation may be 0.871748, with a power score of 374.63. In some embodiments, a potential cluster may be re-sorted (e.g., randomly) and/or the method of pairing molecules may be adjusted multiple times, with one or more characterizing statistics being calculated for newly identified pairs each time. In some embodiments, calculations from a plurality of re-sortings may be further combined, averaged, or otherwise analyzed and/or accounted for, etc., e.g., to enhance the accuracy of the characterizing statistics.

In some embodiments, once the characterizing statistic(s) have been calculated, the processor may determine whether the overall commonality (of the molecules in the potential cluster) is above a second predefined threshold based on the calculated characterizing statistic(s). For example, the second predefined threshold may be predefined minimum average number of matching K-mer sequences in a given pair of molecule in the potential cluster (e.g., y≧10). As such, at step 255, potential clusters which meet this heightened criteria (e.g., the molecules in the potential cluster which have an overall commonality above the second predefined threshold) may be defined (e.g., identified by the processor) as an established cluster, whereas potential clusters which do not meet this heightened criteria may not be defined as an established cluster.

At step 260, in some embodiments, any potential clusters which do not have an overall commonality above the second predefined threshold may be destroyed. For example, molecules that were previously assigned a label, tagged, placed in or otherwise designated as being part of a potential cluster may be removed and/or reassigned, e.g., to the original set of molecules and/or placed with those molecules not placed in a potential cluster. In some embodiments, molecules from destroyed potential clusters may be placed in or otherwise assigned to a temporary grouping, until a new seed group may be generated from among all the molecules which are in an established cluster.

At step 265, in some embodiments, each potential cluster that is defined as an established cluster may be recorded by the processor in the database. In some embodiments, established clusters may be recorded and/or stored along with information regarding the commonality of the molecules that make up the cluster, such as, for example, with the molecule index associated with the molecules in the established cluster, and/or the characterizing statistic(s) of the established cluster, as described herein.

At step 270, in some embodiments, the processor may remove from the total K-mer-set any K-mer sequence which is included in an established cluster. In some embodiments, this may be accomplished, for example, by removing the molecules in the established cluster from the set of molecules, which, for example, may cause the K-mer sequences associated with a given molecule to be removed from the total K-mer-set. In some embodiments, to remove a K-mer sequence from the total K-mer-set, the processor may, for example, assign a label, tag, or other indicator, indicating, for example, that the K-mer sequence and/or the molecule with which the K-mer sequence is associated has been accounted for in the clustering process. In some embodiments, for example, when data representing the respective K-mer sequences and/or molecules has been stored together in the database (e.g., in a table, as a list, etc.) as described herein, any accounted for K-mer sequence, and/or the molecule with which the K-mer sequence is associated, may be removed, e.g., to a different table, list, etc.

At step 275, in some embodiments, the processor may determine whether any K-mer sequences remain in the total K-mer-set and/or whether any molecules from the set of molecules remain non-clustered. In some embodiments, provided there are molecules which remain non-clustered (e.g., K-mer sequences remain in the total K-mer-set), the processor may identify or choose a second seed group of K-mer sequences from the remaining K-mer sequences in the total K-mer-set, and continue to define established clusters. In some embodiments, this process may continue, for example, until a predetermined number of seeds groups are identified, and/or a predetermined number of established clusters are defined (e.g., an absolute number, a ratio/percentage of the entire set of molecules, etc.). In some embodiments, this process may continue, for example, until a predetermined number of K-mer sequences remain in the total K-mer-set and/or until a predetermined number of molecules remains in the set of molecules. In some embodiments, any non-clustered molecule which remains when the clustering terminates may be assigned a label, tag, or other indicator, indicating, for example, that the molecule was not clustered into any established cluster. It should be noted that, in some embodiments, the first threshold and/or the second threshold may be adjusted as necessary, for example if an expected and/or predetermined number of established clusters has not been reached by the end of the clustering.

At step 280, in some embodiments, once the established clusters have been defined, the processor may select one or more representative molecules from each established cluster. For example, in some embodiments, a representative molecule may be randomly selected by the processor. In some embodiments, the processor may select a representative molecule of a given established cluster by evaluating the molecules in the cluster relative to each other, and selecting the molecule or molecules which, for example, most closely reflects the commonality of the molecules in the established cluster (e.g., an “epicenter”). For example, if the molecules in an established cluster, on average, contain a particular group of common K-mer sequences, such a molecule may be a candidate for selection as a representative of the established cluster. In some embodiments, a union of K-mer sequences from all molecules of the established cluster may define a new “chimeric” molecule which may represent the cluster in the example bottom-up recursive clustering described herein. In some embodiments, the processor may generate a cluster representation database which may include the selected representative molecules. As such, the cluster representation database may be used, for example, for locating clusters of interest, and/or for screening purposes, as described herein.

At step 285, in some embodiments, the processor may receive a previously unscreened molecule (e.g., a molecule that is unsorted, unknown, and/or untested by the system until the point in time in which it is to be screened, etc.) and screen the previously unscreened molecule against the selected representative molecules. For example, the previously unscreened molecule may be compared with data of 35,000 representative molecules representing 35,000 established clusters of molecules, rather than screening the entire set of molecules (containing, for example, 2.5 million molecules), as described herein. Screening the previously unscreened molecule against the representative molecules may produce one or more candidate established clusters of molecules against which testing/analysis may be done. Of course, in some embodiments, such as, for example, when an established cluster of interest is already known and/or has already been located, e.g., via other means, screening against the representative molecules may not be necessary, required, or desired. As such, in some embodiments, the processor may receive a previously unscreened molecule and screen the previously unscreened molecule against one or more established clusters recorded in the database, such as, for example, an established cluster known or believed to contain molecules with one or more similar traits/characteristics to the previously unscreened molecule.

It will of course be clear to those of skill in the art that implementation of the clustering process described herein does not preclude implementation of the alignment process described herein, and vice versa. For example, in some embodiments, once an established cluster of interest has been identified, e.g., by screening a previously unscreened molecule against the cluster representation database, the alignment process may then be implemented in order to compare the new molecule directly with one or more molecules in the established cluster.

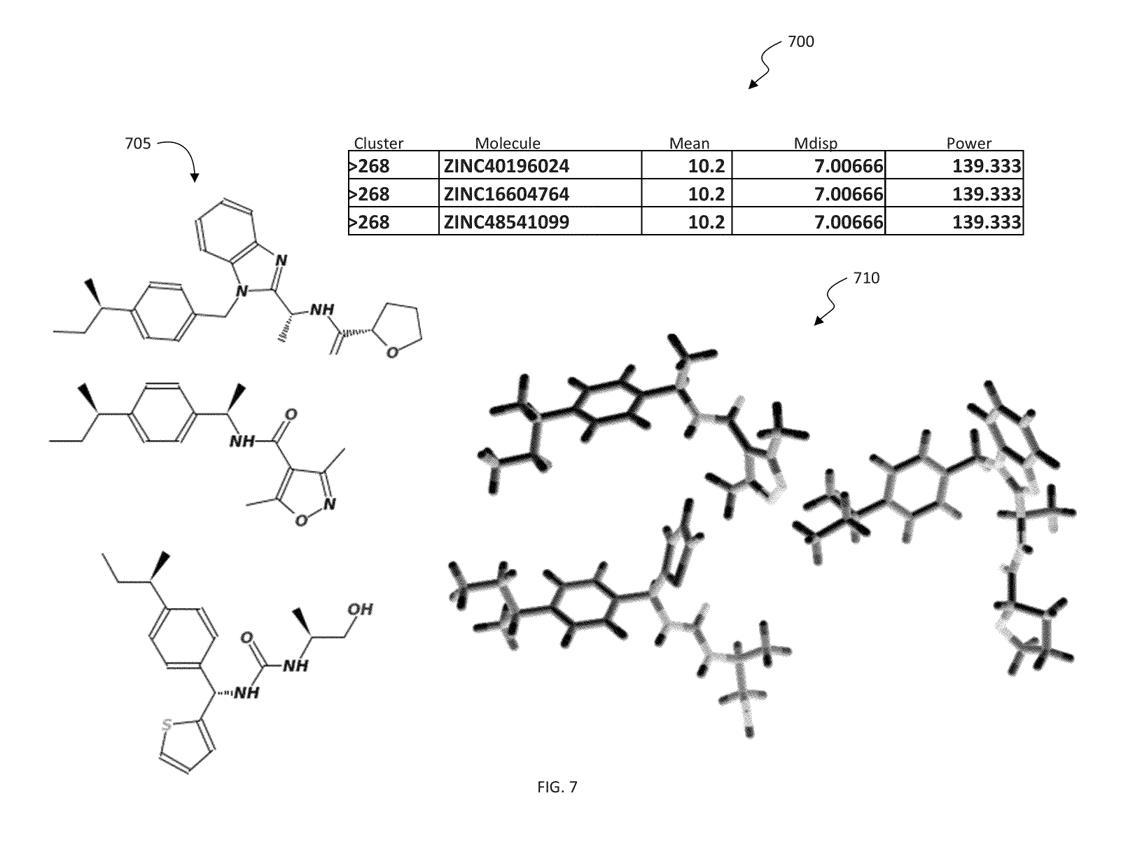

FIG. 7 depicts various example representations of an established cluster (Cluster #268), according to at least one embodiment of the invention. As reflected in graph 700, molecules which have been clustered together may be outputted (e.g., displayed or otherwise provided to an end user or other system function), e.g., in graphical form, in list form, etc. In some embodiments, one or more characterizing statistics of the established cluster may be presented along with the clustered molecules, such as, for example, the mean, the standard deviation (“Mdisp”), a power score (as described herein), etc. Example established cluster #268 has three (3) molecules clustered therein, including molecules @ZINC16604764 and @ZINC4019624 of FIG. 4A, as well as a third molecule @ZINC48541099. In some embodiments, clusters may additionally or alternatively be represented and/or outputted as condensed structural models of the three molecules (705), and/or as 3D models of the molecules (710). Of course, other additional and/or alternative representations of an established cluster may also be outputted in accordance with embodiments of the invention.

Unless explicitly stated, the method embodiments described herein are not constrained to a particular order or sequence. Furthermore, all formulas described herein are intended as examples only and other or different formulas may be used. Additionally, some of the described method embodiments or elements thereof may occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

What is claimed is:

1. A method of improved molecule screening, performed on a computer having a processor, memory, and one or more code sets stored in the memory and executing in the processor, the method comprising:
for each molecule in a set of molecules, each molecule comprising one or more atoms:
assigning, by the processor, a key string to each atom of the molecule, wherein a key string comprises one or more key attribute indicators of the atom to which the key string is assigned; and
generating, by the processor, for each atom of the molecule, a K-mer sequence, wherein:
a K-mer sequence comprises an ordered sequence of respective assigned key strings of a defined number of neighboring atoms to a given atom;
a molecule K-mer-set comprises all K-mer sequences associated with a particular molecule; and
a total K-mer-set comprises all generated K-mer sequences of all the molecule K-mer-sets;
identifying, by the processor, a first seed group of K-mer sequences being from the total K-mer-set;
generating, by the processor, a molecule index for one or more molecules in the set of molecules based on a commonality of a given molecule K-mer-set with the first seed group of K-mer sequences relative to a first predefined threshold; and
clustering, by the processor, into a potential cluster, all molecules in the set of molecules having the same molecule index.

2. The method as in claim 1, further comprising:
for each potential cluster, determining, by the processor, whether the molecules in the potential cluster have an overall commonality above a second predefined threshold, such that the potential cluster can be defined as an established cluster; and
recording, by the processor, in a database each potential cluster which is defined as an established cluster.

3. The method as in claim 1, wherein generating the molecule index for one or more molecules in the set of molecules comprises:
identifying a group of one or more K-mer sequences of the given molecule K-mer-set which are common to the molecule K-mer-set and the first seed group, wherein each K-mer sequence has an associated K-mer index; and
implementing a hash function with respect to the associated K-mer indices of the one or more K-mer sequences of the identified group, wherein the molecule index is an output of the hash function.

4. The method as in claim 3, wherein the clustering into the potential cluster all the molecules in the set of molecules having the same molecule index further comprises: sorting all molecules with the same molecule index into the potential cluster.

5. The method as in claim 1, wherein the ordered sequence of respective assigned key strings of each K-mer sequence is ordered by a relative distance of each of the defined number of neighboring atoms to the given atom.

6. The method as in claim 1, wherein the first seed group of K-mer sequences is identified by a random selection of a predetermined number of K-mer sequences from the total K-mer-set.

7. The method as in claim 2, further comprising:
removing from the total K-mer-set any K-mer sequence which is included in an established cluster;
identifying, by the processor, a second seed group of K-mer sequences from the remaining K-mer sequences in the total K-mer-set; and
continuing to define established clusters until one of a predetermined number of seeds groups are identified, and a predetermined number of established clusters are defined.

8. The method as in claim 1, wherein the one or more key attribute indicators of an atom comprise one or more of: potential hydrogen bond donor status, potential hydrogen bond acceptor status, bulkiness, and electropositivity.

9. The method as in claim 8, wherein the one or more atoms of a molecule further comprises one or more pseudo-atoms, and wherein the key string assigned to a respective pseudo-atom comprises a key attribute indicator indicating whether the pseudo-atom is a center of an aromatic ring, or whether the pseudo-atom is a center of a non-aromatic ring.

10. The method as in claim 1, wherein the first predefined threshold comprises a minimum number of K-mer sequences required to be common to both a given molecule K-mer set and the first seed group.

11. The method as in claim 2, wherein determining, by the processor, whether the molecules in the potential cluster have an overall commonality above a second predefined threshold further comprises:
for one or more randomly chosen sortings of molecules within the potential cluster, identifying a number of matching K-mer sequences between one or more pairs of molecules in a given sorting;
calculating a characterizing statistic for the potential cluster based on the identified number of matching K-mer sequences between the one or more pairs of molecules across at least one of the one or more randomly chosen sortings; and
determining whether the overall commonality is above the second predefined threshold based on the calculated characterizing statistic;
wherein the characterizing statistic comprises at least one of an average, a mean, a median, a mode, a standard deviation, and a statistical significance score of the potential cluster.

12. The method as in claim 2, further comprising receiving a previously unscreened molecule and screening the previously unscreened molecule against one or more established clusters recorded in the database.

13. The method as in claim 2, further comprising:
selecting one or more representative molecules from each established cluster; and
generating a cluster representation database comprising the selected representative molecules.

14. The method as in claim 13, further comprising receiving a previously unscreened molecule and screening the previously unscreened the molecule against the selected representative molecules.

15. A system in support of improved molecule screening comprising:
a computer having:
a processor;
a memory; and
one or more code sets stored in the memory and executing in the processor, which, when executed, configure the processor to:
for each molecule in a set of molecules, each molecule comprising one or more atoms:
assign a key string to each atom of the molecule, wherein a key string comprises one or more key attribute indicators of the atom to which the key string is assigned; and
generate for each atom of the molecule, a K-mer sequence, wherein:
a K-mer sequence comprises an ordered sequence of respective assigned key strings of a defined number of neighboring atoms to a given atom;
a molecule K-mer-set comprises all K-mer sequences associated with a particular molecule; and
a total K-mer-set comprises all generated K-mer sequences of all the molecule K-mer-sets;
identify a first seed group of K-mer sequences being from the total K-mer-set;
generate a molecule index for one or more molecules in the set of molecules based on a commonality of a given molecule K-mer-set with the first seed group of K-mer sequences relative to a first predefined threshold; and
cluster into a potential cluster, all molecules in the set of molecules having the same molecule index.

16. The system as in claim 15, wherein the one or more code sets, when executed, cause the processor to:
for each potential cluster, determine whether the molecules in the potential cluster have an overall commonality above a second predefined threshold, such that the potential cluster can be defined as an established cluster; and
record in a database each potential cluster which is defined as an established cluster.

17. The system as in claim 15, wherein when the processor generates the molecule index for one or more molecules in the set of molecules, the code sets, when executed, cause the processor to:
identify a group of one or more K-mer sequences of the given molecule K-mer-set which are common to the molecule K-mer-set and the first seed group, wherein each K-mer sequence has an associated K-mer index; and
implement a hash function with respect to the associated K-mer indices of the one or more K-mer sequences of the identified group, wherein the molecule index is an output of the hash function.

18. The system as in claim 17, wherein the one or more code sets, when executed, cause the processor to: sort all molecules with the same molecule index into the potential cluster.

19. The system as in claim 15, wherein the ordered sequence of respective assigned key strings of each K-mer sequence is ordered by a relative distance of each of the defined number of neighboring atoms to the given atom.

20. The system as in claim 15, wherein the first seed group of K-mer sequences is identified by a random selection of a predetermined number of K-mer sequences from the total K-mer-set.

21. The system as in claim 16, wherein the one or more code sets, when executed, cause the processor to:
remove from the total K-mer-set any K-mer sequence which is included in an established cluster;
identify a second seed group of K-mer sequences from the remaining K-mer sequences in the total K-mer-set; and
continue to define established clusters until one of a predetermined number of seeds groups are identified, and a predetermined number of established clusters are defined.

22. The system as in claim 15, wherein the one or more key attribute indicators of an atom comprise one or more of: potential hydrogen bond donor status, potential hydrogen bond acceptor status, bulkiness, and electropositivity.

23. The system as in claim 22, wherein the one or more atoms of a molecule further comprises one or more pseudo-atoms, and wherein the key string assigned to a respective pseudo-atom comprises a key attribute indicator indicating whether the pseudo-atom is a center of an aromatic ring, or whether the pseudo-atom is a center of a non-aromatic ring.

24. The system as in claim 15, wherein the first predefined threshold comprises a minimum number of K-mer sequences required to be common to both a given molecule K-mer set and the first seed group.

25. The system as in claim 16, wherein when the processor determines whether the molecules in the potential cluster have an overall commonality above a second predefined threshold, the one or more code sets, when executed, cause the processor to:
for one or more randomly chosen sortings of molecules within the potential cluster, identify a number of matching K-mer sequences between one or more pairs of molecules in a given sorting;
calculate a characterizing statistic for the potential cluster based on the identified number of matching K-mer sequences between the one or more pairs of molecules across at least one of the one or more randomly chosen sortings; and
determine whether the overall commonality is above the second predefined threshold based on the calculated characterizing statistic;
wherein the characterizing statistic comprises at least one of an average, a mean, a median, a mode, a standard deviation, and a statistical significance score of the potential cluster.

26. The system as in claim 16, wherein the one or more code sets, when executed, cause the processor to: receive a previously unscreened molecule and screening the previously unscreened molecule against one or more established clusters recorded in the database.

27. The system as in claim 16, wherein the one or more code sets, when executed, cause the processor to:
select one or more representative molecules from each established cluster; and
generate a cluster representation database comprising the selected representative molecules.

28. The system as in claim 27, wherein the one or more code sets, when executed, cause the processor to: receive a previously unscreened molecule and screening the previously unscreened the molecule against the selected representative molecules.

29. A method of improved molecule screening, performed on a computer having a processor, memory, and one or more code sets stored in the memory and executing in the processor, the method comprising:
receiving, by the processor, a set of molecules, wherein each molecule comprises one or more atoms, each of the one or more atoms of each molecule having been assigned a key string, wherein a key string comprises one or more key attribute indicators of the atom to which the key string is assigned; and wherein, for each atom of the molecule, a K-mer sequence has been generated, wherein:
a K-mer sequence comprises an ordered sequence of respective assigned key strings of a defined number of neighboring atoms to a given atom;
a molecule K-mer-set comprises all K-mer sequences associated with a particular molecule; and
a total K-mer-set comprises all generated K-mer sequences of all the molecule K-mer-sets;
identifying, by the processor, a first seed group of K-mer sequences being from the total K-mer-set;
generating, by the processor, a molecule index for one or more molecules in the set of molecules based on a commonality of a given molecule K-mer-set with the first seed group of K-mer sequences relative to a first predefined threshold; and
clustering, by the processor, into a potential cluster, all molecules in the set of molecules having the same molecule index.
